(19) United States
(12) Patent Application Publication
(10) Pub. No.: US 2015/0045171 A1
(43) Pub. Date: Feb. 12, 2015

(54) AXLE DIFFERENTIAL TRANSMISSION FOR AN ENGAGEABLY DRIVEN VEHICLE OF A MOTOR VEHICLE

(71) Applicant: Schaeffler Technologies GmbH & Co. KG, Herzogenaurach (DE)

(72) Inventors: Ralph Schimpf, Fuerth (DE); Franz Kurth, Nuernberg (DE); Thorsten Biermann, Wachenroth (DE); Brian Lee, York, SC (US)

(21) Appl. No.: 14/327,096

(22) Filed: Jul. 9, 2014

(30) Foreign Application Priority Data
Aug. 12, 2013 (DE) 102013215888.2

(51) Int. Cl. F16H 48/22

(52) U.S. Cl. CPC F16H 48/22
USPC 475/249

(57) ABSTRACT

An axle differential transmission for an engageably driven vehicle axle, which has two shaft ends and is part of a motor vehicle, wherein said axle differential transmission comprises a clutch assembly, which is integrated in a transmission case between a drive shaft and a housing input shaft of a differential stage, for selectively connecting a drive to the vehicle axle. The clutch assembly comprises clutch plates, wherein at least one part of the clutch plates comprises freewheel means, in order to transmit the driving torque, generated by the drive shaft in the torque transmission direction of the freewheel means that corresponds to a forward direction of travel of the motor vehicle, to the differential stage, as soon as this differential stage is above a defined limit torque and the driving torque is distributed in equal parts to the shaft ends of the vehicle axle.

### CROSS-REFERENCE TO RELATED APPLICATIONS

This patent application is filed under 35 U.S.C. §119(a) and claims priority to German Patent Application No. DE102013215888.2, filed Aug. 12, 2013, which application is hereby incorporated by reference in its entirety.

### FIELD OF THE INVENTION

The invention relates to an axle differential transmission for an engageably driven vehicle axle, which has two shaft ends and is part of a motor vehicle, wherein said axle differential transmission comprises a clutch assembly, which is integrated in a transmission case between a drive shaft and a housing input shaft of a differential stage, for selectively connecting a drive to the vehicle axle.

### BACKGROUND OF THE INVENTION

The trend towards increasingly smaller and lighter four-wheel drive vehicles is leading to four-wheel drive systems, in which the drive power is transmitted, according to specific requirements, from a primary driven front axle to a secondary driven rear axle by means of a clutch. For this purpose an axle differential transmission with engageable drive power of the kind that is of interest herein can be used in the area of the rear axle.

In most cases a clutch assembly is integrated directly in the transmission case between the transmission input shaft, which is disposed on the rear axle along the vehicle for transmitting the driving torque from the front axle to the rear axle, and the input shaft of the differential transmission for a rear axle engagement of the drive. The multiple disk clutch, which is usually designed to cope with the axle torque, is arranged between the crown wheel on the transmission input side and the differential stage. This arrangement makes it possible to disengage the differential with the side shafts from the hypoid drive in the shut down mode. In addition, this arrangement permits a compact design of the rear axle and makes it possible to gain additional design space in the area of the longitudinally arranged transmission input shaft. However, the field of application of the invention is not limited to just an engageably driven rear axle of a vehicle alone. It is also conceivable to assign an axle differential transmission of the type that is of interest here to the front axle of a motor vehicle or to the central axle, provided that the objective is to apply a drive power, which can be engaged on demand, to these axles.

DE 10 2008 037 886 A1 discloses a technical solution for switching off the four-wheel drive at the axle differential transmission of the rear axle of a vehicle. The drive assembly comprises a transfer case, which is assigned to the front axle of the vehicle and which distributes a torque, which is introduced by the drive unit of the motor vehicle, to a first drive train and to a second drive train, wherein the first drive train is permanently drive-connected to the transfer case, in order to transmit a torque to the front axle of the vehicle. In contrast, the second drive train is engageably connected to the transfer case, in order to also transmit a torque to the rear axle of the vehicle, for which purpose a longitudinal drive shaft transmits the torque flow between the transfer case and the rear axle of the vehicle. Within the framework of the drive assembly there are provided first clutch means for coupling and uncoupling the longitudinal drive shaft relative to the drive unit of the motor vehicle as well as second clutch means for coupling and uncoupling the longitudinal drive shaft relative to the rear axle of the vehicle.

To date the second clutch means, which is of interest here and which may be found at the engageably driven axle of a vehicle, has consisted, in principle, of a friction clutch, which is constructed from clutch plates. In this case the friction clutch makes it possible to transmit the torque by means of an axially oriented actuator by pressing the clutch plates against each other.

DE 2008 037 885 A1 discloses an additional solution for the clutch means for an engageably driven vehicle axle in a motor vehicle driven by multiple axles. These clutch means also comprise an externally controllable friction clutch with a clutch input member, which can be driven in such a way that it rotates about an axis of rotation, and with a clutch output member. The clutch means also comprise a differential transmission with an input element and two output elements, which are drive-connected to the input element, wherein this input element of the differential transmission is arranged coaxially to the clutch output member and is driveably connected to the clutch output member, in order to transmit a torque.

In these solutions known from the prior art, the friction clutch in the engageable four-wheel drive is under constant strain. This applies, in particular, to the bearings of the ramp actuators that are often used for actuating the clutch, because in order to transmit the torque, the axial force, which is generated by the actuator, on the clutch plates, has to be maintained. The net result is that there are a plurality of clutch plates that are relatively large in size and an actuator that is dimensioned accordingly.

### BRIEF SUMMARY OF THE INVENTION

Therefore, the object of the present invention is to provide an axle differential transmission for an engageably driven vehicle axle in the motor vehicle, wherein the integrated clutch assembly of said axle differential transmission is under as small a load as possible in the engaged driving mode. Furthermore, said clutch assembly is designed so as to be compact and to exhibit a small overall size.

The invention includes the technical teaching that the clutch assembly comprises clutch plates, wherein at least one part of the clutch plates has freewheel means, in order to transmit the driving torque, generated by the drive shaft in the torque transmission direction of the freewheel means that corresponds to a forward direction of travel of the motor vehicle, to the differential stage, as soon as this differential stage is above a defined limit torque and the driving torque is distributed in equal parts to the shaft ends of the vehicle axle.

In other words, the freewheel means, which are integrated into the clutch assembly, are used to transmit the peak torque in a drive direction, preferably the forward direction of travel. The solution according to the invention enables a smooth engagement of the four-wheel drive in preferably the forward direction of travel by at least partially actuating the clutch, so that the jerky engagement of the freewheel unit is damped. The clutch plates enable a first synchronization, before the entire torque is transmitted by means of the freewheel means to the differential stage and then by way of said differential stage to the vehicle axle. Since the freewheel means take over the torque transmission in the range of the high torque levels, the load on the clutch assembly is reduced, because the freewheel does not engage suddenly and abruptly. Instead, the freewheel is slowed down by means of a slight actuation of the clutch. As a result, the contact forces for the clutch plates of the clutch assembly in the forward drive mode can be reduced, because only thrust moments are absorbed by way of the clutch assembly. However, in the reverse travel mode, the contact force of the clutch assembly has to be increased; or, as an alternative, the torque has to be reduced compared to the forward travel mode.

It is even more preferred that by just closing the clutch plates alone the clutch assembly transmits the driving torque to the differential stage in a freewheeling direction of the freewheel means, where said freewheeling direction corresponds to a reverse direction of travel of the motor vehicle. Therefore, while preferably the engagement of the four-wheel drive at the axle differential in the forward direction of travel is carried out, in principle, by means of the freewheel means, the engagement in the reverse direction of travel is carried out by means of an actuation of the friction clutch.

Preferably a mechanical ramp actuator is provided for closing the clutch plates. For this purpose the ramp actuator comprises two actuator shafts, which are designed as hollow shafts and which are arranged coaxially to the housing input shaft of the differential stage. Such a ramp actuator can be integrated into the transmission case in such a way that the design envelope is reduced. As an alternative, it is also possible to use, for example, a hydraulic actuator for actuating the clutch. The clutch plates are closed preferably by means of a hydraulically operated cylinder.

According to a preferred embodiment of the invention, the one part of the clutch plates is fastened to the housing of the angular drive, while the other part of the clutch plates, which correspond to the clutch plates of the former part, is fastened to the housing input shaft of the differential stage. The freewheel means are integrated in one of the parts of the clutch plates, preferably in the part of the clutch plates that are arranged on the side of the input shaft of the differential stage.

In this case the clutch plates, which have the shape of annular disks and are provided with the freewheel means, are arranged on the input shaft of the differential stage. Said clutch plates are provided with a pawl contour on the outer periphery, where said pawl contour interacts with a positively corresponding inner contour of the clutch plate. The clutch plates, which have the shape of annular disks and are provided with the freewheel means, are designed with preferably a plurality of spring sections that are arranged along the periphery. These spring sections enable a variable change in the diameter of the clutch plates that have the shape of annular disks, so that the effect of these spring sections is a non-positive engagement with the housing of the angular drive on the outer periphery in the blocking direction of the freewheel means; and, when the clutch is released, said spring sections ensure a freewheel in the opposite freewheeling direction.

Preferably the freewheel means open upon elimination of the driving torque, generated in the forward direction of travel of the motor vehicle, on the transmission input shaft. The result is an opening of the freewheel on stoppage of the driven transmission input shaft, which is arranged longitudinally, and with a simultaneous thrust moment by way of the axle of the vehicle. Thus, the freewheel is released with the elimination of the drive owing to the clutch arrangement.

### BRIEF DESCRIPTION OF THE DRAWINGS

Additional features that improve the invention are explained in detail below together with the description of a preferred exemplary embodiment of the invention with reference to the figures, where:

FIG. 1 is a schematic diagram of a two-axle, four-wheel drive vehicle with an engageably driven axle of the vehicle;

FIG. 2 is a longitudinal view of an axle differential transmission for the engageably driven axle of the vehicle from FIG. 1 with an integrated clutch assembly; and,

FIG. 3 is a cross sectional view of the axle differential transmission from FIG. 2 in the area of the clutch assembly.

### DETAILED DESCRIPTION OF THE INVENTION

According to FIG. 1, the drive train 1 of a motor vehicle, which is not shown in detail, consists of a front axle 7 of a motor vehicle, wherein this front axle is driven by way of a transfer case 4 by means of an internal combustion engine 2 of the motor vehicle. Said drive train also consists of a rear axle 10 of a motor vehicle, wherein said rear axle is engageably driven by means of an axle differential transmission 3.

In this context the front axle 7 of the motor vehicle is permanently driven, starting from a transfer case 4 and, upstream of said transfer case, a main transmission 3, by means of a front axle differential 6 and a front drive shaft 5.

The rear axle differential transmission 9 is driven by means of a second shaft, which is arranged downstream of the transfer case 4 and which is referred to herein as the rear drive shaft 8. This rear axle differential transmission transmits in an engageable manner a proportional torque in equal parts to the shaft ends of the rear axle 10 of the motor vehicle.

The rear axle differential transmission 9 comprises an angular drive 13, a clutch assembly 14 and a differential stage 15, which applies the driving torque in equal parts to the two shaft ends of the rear axle 10 of the motor vehicle. The clutch assembly 14, which is disposed between the angular drive 13 and the differential stage 15, is used to couple or interrupt the torque flow between the transfer case 4 and the rear axle 10 of the motor vehicle.

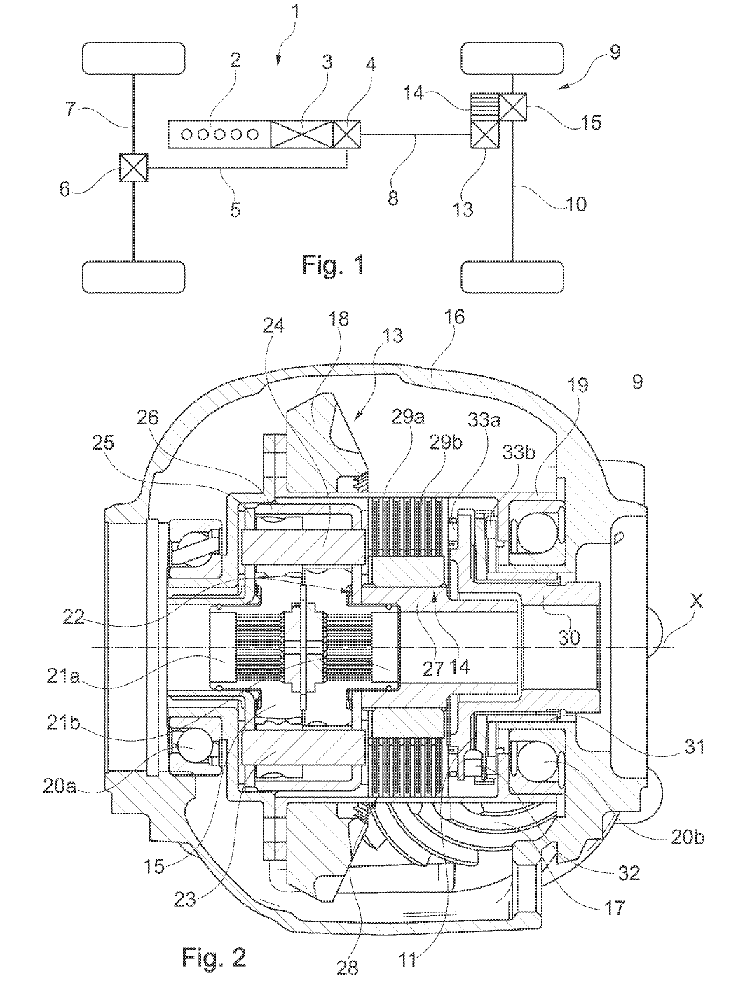

According to FIG. 2, the angular drive 13, the clutch assembly 14 and the differential stage 15 of the rear axle differential transmission 9 are housed in a common first transmission case 16.

The angular drive 13 comprises a pinion 17, which is connected in a rotationally rigid manner to the rear drive shaft 8; a driving gear 18; and a housing 19, which is mounted in a first transmission case 16 by means of two bearings 20a, 20b in such a way that said housing can be rotated in relation to a transmission axis X. The term angular drive refers to the fact that the pinion 17 transmits the driving torque at a fixed ratio to the driving gear 18 by means of a suitably designed gear tooth system, as a result of which a central axis of the pinion 17 is oriented at an angle of about 90° to the central axis of the driving gear 18.

The differential stage 15 comprises two output sun gears 21a, 21b and a planetary gear assembly, which is accommodated in a housing 22, for coupling the two output sun gears 21a, 21b in such a way that they can move in a rotational manner in the opposite direction. The planetary gear assembly comprises a first planet 23 and a second planet 24, each of which is arranged on a periphery of the respective output sun gear 21a or 21b; and both planets are operatively connected to each other. In this respect the first planet 23 is in contact with the output sun gear 21a, while the second planet 24, which is about twice as long as the first planet 23 and covers the width of the gear tooth system of the output sun gears 21a, 21b, is in contact with the output sun gear 21b. The gear ratio of the geared coupling, existing between the output sun gears 21a, 21b, amounts to −1. The output sun gears 21a, 21b are connected to the shaft ends of the rear axle 10 of the motor vehicle. The housing 22 has a housing cover 25, a housing cup 26 and a housing input shaft 27, all of which are rigidly connected to each other. The housing input shaft 27 is connected to the housing cup 26 by means of friction welding.

The clutch assembly 14 comprises a clutch plate pack 28 and an actuator 11 and enables the engagement or disengagement of the torque between the housing 19 of the angular drive 13 and the housing 22 of the differential stage 15. In so doing, a part of the clutch plates 29a of the clutch plate pack 28 is fastened to the housing input shaft 27, while the other part of the corresponding clutch plates 29b is fastened to the housing 19 of the angular drive 13.

The actuator 11, which actuates the clutch assembly 14, comprises a first actuator shaft 30, which is designed as a hollow shaft, and a second actuator shaft 31, which is also designed as a hollow shaft; and both actuator shafts are arranged coaxially to the transmission axis

X. Both actuator shafts 30, 31 exhibit ramp contours, between which a rolling member 32, which is shown herein as a roller, is disposed. The two actuator shafts 30, 31 can be rotated relative to each other about a defined angle, which is a function of the length of the ramps. The maximum theoretical torsion angle of the rolling member 32 is at most 360°. The sides of the two actuator shafts 30, 31 that are opposite the ramp contours are mounted axially between the housing 19 and the clutch plate pack 28 by means of axial needle bearings 33a, 33b in such a way that said actuator shafts can be rotated about the transmission axis X.

If the actuator shafts 30, 31 are rotated against each other by means of an actuating unit, which is not shown in detail, then the angular displacement motion causes an axial movement to the clutch plates 35a, 35b. Since these clutch plates are trimmed owing to the inner design envelope of the housing 19, the net result is that the actuating force becomes increasingly larger after a defined angle of rotation of the actuator shafts 30, 31; and this actuating force compresses the clutch plates 35a, 35b and generates an increasingly larger frictional force between the clutch plates 35a, 35b. This frictional force generates a defined torque between the clutch plates 35a, 35b, so that the clutch assembly 14 is totally or partially closed.

The one part of the clutch plates 35a comprises additionally integrated freewheel means 12, in order to transmit the torque of the angular drive 13 to the subsequent differential stage 15, wherein said torque corresponds to the forward direction of travel of the motor vehicle. The transmission of the torque by way of the locking direction of the freewheel means 12 occurs after a defined limit torque, so that in the range of the driving torque below said limit torque the torque transmission by way of the clutch assembly 14 is carried out only by means of the compression of the clutch plates 29a, 29b. Such an arrangement is achieved by the fact that the housing input shaft 27 is not connected, like the multiple disk clutches, in the typically standard way by means of a rotationally rigid gear tooth system to the clutch plates 29a on the periphery, but rather by means of ramps 34 that are arranged on the periphery. Since the clutch plates 29a are not closed on the periphery, a radial expansion of the clutch plates 29a is generated when the housing input shaft 27 is rotated to the clutch plates 29a. This radial expansion has the effect of transmitting the torque in a friction locking manner to an outer peripheral face of the clutch plates 29a and to an inner peripheral face 35 of the housing 19. Owing to the design of the ramps 34 and the torque that is applied, high contact pressure levels are generated at the inner peripheral face 35; and this contact pressure is considerably higher than the clutch torque that is generated by the actuator force.

The freewheel unit cannot be actuated in the reverse direction of travel of the motor vehicle. In the corresponding freewheeling direction of the freewheel means 12 the driving torque is transmitted to the differential stage 15 only by closing the clutch plates 29a, 29b, because in the freewheeling direction the locking effect of the freewheel means 12 is cancelled. In this case the torque transmission is not carried out by way of the ramps 34, but rather by way of the tooth contour 38 of the pawls of the clutch plates 29a.

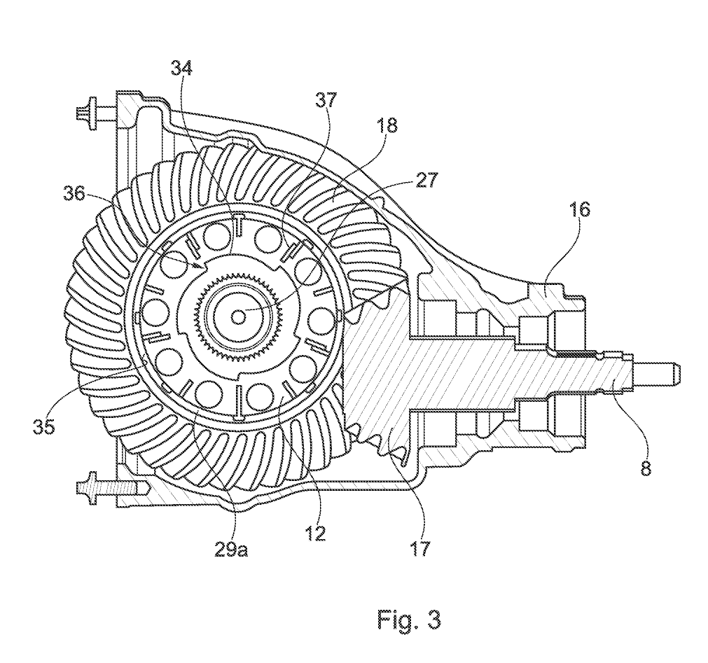

According to FIG. 3, a clutch plate 29a, which exhibits, for example, the shape of an annular disk and is provided with the freewheel means, is disposed on the housing input shaft 27 of the differential stage 15. The outer periphery of the housing input shaft 27 comprises pawls, consisting of the ramp 34 and the tooth contour 36, both of which interact with a positively corresponding inner contour of the clutch plate 29a. The clutch plate 29a, which exhibits the shape of an annular disk and is provided with the freewheel means 12, is provided with a plurality of spring sections 37, which are arranged along the periphery. These spring sections 37 enable the clutch plate 29a, which has the shape of an annular disk, to execute a change in diameter in relation to the housing input shaft 27, in order to fulfill the objective of uncoupling the differential stage 15 in the freewheeling direction. On the other hand, in the opposite driving direction the housing input shaft 27 is driven by the tooth contour 36.

The invention is not limited to the above described preferred exemplary embodiments. Conceivable are also modifications that are covered by the scope as stated in the following claims. Hence, it is also possible, for example, that a motor vehicle axle other than the rear axle 10 of the motor vehicle can be driven in a correspondingly engageable manner. In addition, the forward and reverse direction of travel of the motor vehicle and the corresponding operative direction of the freewheel means are interchangeable. Furthermore, at least three rolling members can be used in order to support the actuator shafts 30, 31 in an optimal way. Then the maximum torsion angle amounts to approximately 120° without suitable consideration of the tolerances.

### LIST OF REFERENCE NUMBERS

1 drive train

2 internal combustion engine

3 main transmission

4 transfer case

5 front drive shaft

6 front axle differential transmission

7 front axle of the motor vehicle

8 rear drive shaft

9 rear axle differential transmission

10 rear axle of the motor vehicle

11 actuator

12 freewheel means

13 angular drive

14 clutch assembly

15 differential stage

16 transmission case

17 pinion

18 driving gear

19 housing

20a, 20b bearing

21a, 21b driving sun gear

22 housing

23 first planet

24 second planet

25 housing case

26 housing cup

27 housing input shaft

28 clutch plate pack

29a, 29b clutch plates

30 first actuator shaft

31 second actuator shaft

32 rolling member

33a, 33b axial needle bearing

34 ramp

35 inner peripheral face

36 tooth contour

37 spring section

X transmission axis

What is claimed is:

1. An axle differential transmission for an engageably driven vehicle axle (10), which has two shaft ends and is part of a motor vehicle, wherein said axle differential transmission comprises a clutch assembly (14), which is integrated in a transmission case (16) between a drive shaft (8) and a housing input shaft (27) of a differential stage (15), for selectively connecting a drive to the vehicle axle (10), wherein the clutch assembly (14) comprises clutch plates (29a, 29b), wherein at least one part of the clutch plates (29a, 29b) comprises freewheel means (12), in order to transmit the driving torque, generated by the drive shaft (8) in the torque transmission direction of the freewheel means (12) that corresponds to a forward direction of travel of the motor vehicle, to the differential stage (15), as soon as this differential stage is above a defined limit torque and the driving torque is distributed in equal parts to the shaft ends of the vehicle axle (10).

2. The axle differential transmission, as recited in claim 1, wherein by just closing the clutch plates (29a, 29b) alone the clutch assembly (14) transmits the driving torque to the differential stage (15) in a freewheeling direction of the freewheeling means (12) that corresponds to a reverse direction of travel of the motor vehicle.

3. The axle differential transmission, as recited in claim 1, wherein a mechanical ramp actuator (11) is provided for closing the clutch plates (29a, 29b).

4. The axle differential transmission, as recited in claim 3, wherein the ramp actuator (11) comprises two actuator shafts (30, 31), which are designed as hollow shafts and which are arranged coaxially to the housing input shaft (21) of the differential stage (15).

5. The axle differential transmission, as recited in claim 1, wherein a closing of the clutch plates (29a, 29b) is carried out by means of a hydraulically operated cylinder.

6. The axle differential transmission, as recited in claim 1, wherein the one part of the clutch plates (29b) is fastened to the housing (19) of the angular drive (13), while the other part of the corresponding clutch plates (29a) is fastened to the housing input shaft (27) of the differential stage (15).

7. The axle differential transmission, as recited in claim 1, wherein the clutch plates (29a), which have the shape of annular disks and are provided with the freewheel means (12), are arranged on the housing input shaft (27) of the differential stage (15) and exhibit a pawl contour on the outer periphery, where said pawl contour interacts with a positively corresponding inner contour of the clutch plates (29a).

8. The axle differential transmission, as recited in claim 1, wherein the clutch plates (29a), which have the shape of annular disks and are provided with the freewheel means (12), are provided with a plurality of spring sections (37), which are arranged along the periphery, for executing a variable change in diameter.

9. The axle differential transmission, as recited in claim 1, wherein the freewheel means (12) open upon elimination of the driving torque, generated in the forward direction of travel of the motor vehicle, on the drive shaft (8).

10. The axle differential transmission, as recited in claim 1, wherein the clutch assembly (14) is disposed between the angular drive (13) and the differential stage (15) and enables in the open position a relative speed between the housing (19) of the angular drive (13) and the housing (22) of the differential stage (15).

11. The axle differential transmission, as recited in claim 1, wherein the differential stage (15) comprises two output sun gears (21a, 21b), which are coupled in a geared manner by means of a planetary gear assembly, wherein a gear ratio amounts to −1.
